(19) United States
(12) Patent Application Publication
(10) Pub. No.: US 2010/0195557 A1
(43) Pub. Date: Aug. 5, 2010

(54) RADIO COMMUNICATION SYSTEM AND POWER-SAVING METHOD THEREOF

(76) Inventor: Yuuichi Aoki, Tokyo (JP)

Correspondence Address: Mr. Jackson Chen, 6535 N. STATE HWY 161, IRVING, TX, 75039, US

(21) Appl. No.: 12/669,512

(22) PCT Filed: Jun. 25, 2008
(86) PCT No.: PCT/JP2008/061538

§ 371 Date: Jan. 20, 2010

(30) Foreign Application Priority Data
Jul. 24, 2007 (JP) 2007 192020

(51) Int. Cl. H04H 20/71

(52) U.S. Cl. 370/312

(57) ABSTRACT

A radio communication system comprises a parent node transmitting a beacon signal as one-to-many communication at every constant period, and a child node receiving the beacon signal, the parent node and the child node operating in synchronization with each other by using the beacon signal. The child node transmits a schedule notification signal for providing notification of presence/absence of a schedule of data transmission to the parent node, within a predetermined time period between the beacon signals. The parent node transitions into a sleep state until a time of transmitting the next beacon signal, when the parent node cannot detect the schedule notification signal in the predetermined time period.

### TECHNICAL FIELD

The present invention relates to a radio communication system, and more particularly to a radio communication system suitable for application to a radio network such as ZigBee and a power-saving method thereof.

### BACKGROUND ART

In recent years, IEEE (Institute of Electrical and Electronic Engineers) 802.15.4 (commonly referred to as ZigBee) has been proposed as a power-saving radio communication system used in a radio network or in short distance communication and the like for building management, environmental research and the like. Non-Patent Document 1 (IEEE 802.15.4 Wireless MAC and PHY Specifications for LR-WPANs, http://standards.ieee.org/getieee802/download/802.15.4-2003.pdf) describes communication protocols in the IEEE802.15.4 MAC (Media Access Control) layer and PHY (electric physical) layer of this IEEE802.15.4.

IEEE802.15.4 utilizes beacon signals transmitted at every constant time interval in order to reduce power consumption of each of nodes comprising a network. The beacon signal is transmitted from a parent node, which is referred to as a network coordinator, to each child node in the network. The parent node and the child nodes operate in synchronization with each other using the beacon signals. FIG. 1 shows a configuration of a superframe that serves as a unit of the synchronized operation.

FIG. 1 shows the configuration of the superframe described in FIG. 4 in Chapter 5 of Non-Patent Document 1.

As shown in FIG. 1, a period between the beacon signals transmitted at every constant interval from the parent node is referred to as a Contention Access Period (CAP). IEEE802.15.4 specifies that nodes wishing to communicate using slotted CSMA-CA (Carrier sense multiple access with collision avoidance) mechanism in the CAP. As shown in FIG. 1, the CAP comprises fixed periods (e.g., every 80 ms) referred to as slots. In the slotted CSMA-CA mechanism, data transmission and reception and various processes such as after-mentioned CCA and the like are performed in synchronization with these slots.

FIG. 2 shows a configuration of the beacon frame used for transmitting the beacon signal, which is described in FIG. 10 in Chapter 5 of Non-Patent Document 1.

As shown in FIG. 2, the beacon frame includes a field referred to as a pending address field. The parent node transmits an identification code for identifying an opposite node (child node), that wants to communicate, using this field. When the child node receives the beacon signal from the parent node, the child node detects whether or not the pending address field contains the identification code for identifying itself (i.e. the child node). In the absence of its own identification code, the child node terminates operation and transitions into a sleep state until it receives the next beacon signal. This mechanism allows the child node to reduce power consumption required for a reception process.

In the slotted CSMA-CA mechanism, having a data transmission schedule, when receiving the beacon signal, the child node initially detects whether or not there is an available channel, which is a predetermined radio frequency band used for data transmission, over two slots in the CAP. This detection operation is referred to as CCA (Channel Clear Assignment). The child node randomly delays the CCA that is to be performed first after reception of the beacon signal, for a time period corresponding to 0 to 2^{BE}−1 slots. This delayed time period for CCA is referred to as a backoff, and BE is referred to as a backoff exponent. The reason why the CCA is randomly delayed with respect to each child node is to reduce the possibility of collision (a state where two or more child nodes transmit at the same time). If the child node determines that there is no available channel by the CCA, the child node increments the BE value by one and transitions into the backoff state again.

IEEE802.15.4 also specifies that a communication pause period, which is referred to as an IFS (interframe space), is provided after reception of various frames such as the aforementioned beacon frame and a data frame used for data transmission. Typically, a node requires a certain time period from reception of a frame from another node to transition to the next operation, to process data and the like contained in the frame. In case that another frame is transmitted in the time period, the frame may be unable to be normally received or the data contained in the frame may be unable to be properly processed. The communication pause period, which is referred to as the aforementioned IFS, is provided in order to avoid such problems. IFS includes SIFS (Short IFS) and LIFS (Long IFS). The LIFS (e.g., 160 ms) is provided after reception of a long frame. The SIFS (e.g., 48 ms) is provided after reception of a short frame. After transmission and reception and further a lapse of the aforementioned IFS, each node starts processing from the next slot using slotted CSMA mechanism.

Note that, if a node supports a physical layer capable of half-duplex operation, the node requires a certain time period to switch between a transmission process and a reception process. Provided that the maximum time is aTurnaroundTime (e.g., 48 ms), the SIFS should be at least aTurnaroundTime. That is, aTurnaroundTime≦Tack≦SIFS<LIFS, where Tack is a time period required from receiving a frame to returning the aftermentioned ACK.

According to IEEE802.15.4, a node that transmits a frame can request a node that is to receive the frame to return a confirmation signal, which is referred to as ACK (Acknowledgment), for notification of whether the frame is normally received or not.

When the node that transmits a frame cannot receive an ACK in a certain time period (e.g., 216 ms) after transmission of the frame, the node regards that the frame has not been received normally and performs retransmission and the like. The ACK should be returned within a certain time period after reception of the frame, and should usually be transmitted with higher priority than the other frames such that the other nodes do not start transmission of frames.

IEEE802.15.4 specifies that the ACK is returned within a time period aTurnaroundTime≦Tack<aTurnaroundTime+aUnitBackoffPeriod (e.g., 48 ms≦Tack<128 ms). Note that aUnitBackoffPeriod is the minimum unit of time period of the backoff state.

The request for return of ACK is limited to one-to-one communication, and cannot be used for one-to-many communication like a beacon signal. This is because if the ACKs are returned from nodes at the same time, these collide with each other and cannot be appropriately received.

FIG. 3 shows a configuration of a data frame described in FIG. 11 in Chapter 5 of Non-Patent Document 1.

As shown in FIG. 3, the data frame used for data transmission includes a field referred to as frame control. The frame control field also includes a beacon frame used for transmitting the beacon signal and an ACK frame used for transmitting an ACK.

FIG. 4 shows a format of a frame control field described in FIG. 35 in Chapter 7 of Non-Patent Document 1.

As shown in FIG. 4, the node transmitting the frame uses the sixth bit (bit 5: Ack request) in the frame control field and requests an ACK from the node that is to receive the frame. The node having received the frame should return the ACK when the Ack request (ACK request) in the frame is “1”.

The node transmitting the frame uses the fifth bit (bit 4: Frame pending) in the frame control field and provides notification of whether or not data to be transmitted to a node, that is to receive the frame, exists (remains). The node that transmits the data sets the frame pending in the data frame to “1” when data to be transmitted remains, and sets the frame pending in the frame containing the last data to “0” when data to be transmitted does not remain. The node that has received the frame can determine whether or not all pieces of data have been received by verifying the value of the frame pending of the frame.

Although the aforementioned IEEE802.15.4 specifies a method for reducing power consumption of the child node that receives the beacon signal, it specifies nothing about a method for reducing power consumption of the parent node that transmits the beacon signal. This causes a problem in which the parent node cannot transition into the sleep state to reduce power consumption.

FIG. 5 is a schematic diagram showing an example of a communication operation of a radio communication system employing IEEE802.15.4. Note that FIG. 5 shows an example where a network comprises parent node CH1 and child node CM1. “RX” shown in FIG. 5 represents a node that is in a reception state. “TX” represents a node that is in a transmission state. “IDLE” represents a node that is in the sleep state. “s” shown in FIG. 5 denotes a time period of SIFS. “t” denotes a time period required to switch between the transmission state and the reception state (turnaround time period). “w” denotes an activation time period required for the node to transition from the sleep state to the transmission/reception state.

In the radio communication system employing IEEE802.15.4, when there is for example a schedule of transmitting data from child node CM1 to parent node CH1, child node CM1 terminates data transmission to parent node CH1, and transitions into the sleep state (IDLE) on receiving an ACK from parent node CH1, as shown in FIG. 5 (a). Here arises an unnecessary standby time period for reception because parent node CH1 maintains the reception state until the time of transmitting the next beacon signal even if child node CM1 is in the sleep state.

As shown in FIG. 5 (b), with no schedule of data transmission both in child node CM1 and parent node CH, when the pending address field in the received beacon signal does not contain the identification code for identifying child node CM1, child node CM1 transitions into the sleep state (IDLE) until the time of receiving the next beacon signal. Here arises an unnecessary standby time period for reception over the whole time period of the CAP because parent node CH1 maintains the reception state until the time of transmitting the next beacon signal even if child node CM1 is in the sleep state.

### SUMMARY

Thus, it is an object of the present invention to provide a radio communication system that can reduce power consumption of a child node and a parent node and a power-saving method thereof.

In an aspect of the present invention for achieving the above-described object, the radio communication system comprises a parent node transmitting a beacon signal as one-to-many communication at every constant period, and a child node receiving the beacon signal, the parent node and the child node operating in synchronization with each other by using the beacon signal,

wherein the child node

transmits a schedule notification signal for providing notification of presence/absence of a schedule of data transmission to the parent node, within a predetermined time period between the beacon signals.

On the other hand, a power-saving method of a radio communication system according to an aspect of the present invention, comprising a parent node transmitting a beacon signal as one-to-many communication at every constant period, and a child node receiving the beacon signal, the parent node and the child node operating in synchronization with each other by using the beacon signal, includes:

transmitting a schedule notification signal for providing notification of presence/absence of a schedule of data transmission, from the child node to the parent node, within a predetermined time period between the beacon signals; and

causing the parent node to transition into a sleep state until a time of transmitting the next beacon signal when the parent node cannot detect the schedule notification signal within the predetermined time period.

### BRIEF DESCRIPTION OF THE DRAWINGS

FIG. 1 is a schematic diagram showing a configuration of a superframe described in Non-Patent Document 1.

FIG. 2 is a schematic diagram showing a configuration of a beacon frame described in Non-Patent Document 1.

FIG. 3 is a schematic diagram showing a configuration of a data frame described in Non-Patent Document 1.

FIG. 4 is a schematic diagram showing a format of a frame control field described in Non-Patent Document 1.

FIG. 5 is a schematic diagram showing an example of communication operation of a radio communication system employing IEEE802.15.4.

FIG. 6 is a block diagram showing an example of a configuration of the radio communication system.

FIG. 7 is a block diagram showing an example of a configuration of a node shown in FIG. 6.

FIG. 8 is a schematic diagram showing an example of communication operation of the radio communication system according to a first exemplary embodiment.

FIG. 9 is a state transition diagram showing state transition when the node shown in FIG. 6 communicates.

FIG. 10 is a schematic diagram showing an example of communication operation of a radio communication system according to a second exemplary embodiment.

FIG. 11 is a schematic diagram showing an example of communication operation of a radio communication system according to a third exemplary embodiment.

FIG. 12 is a schematic diagram showing an example of communication operation of the radio communication system according to the third exemplary embodiment.

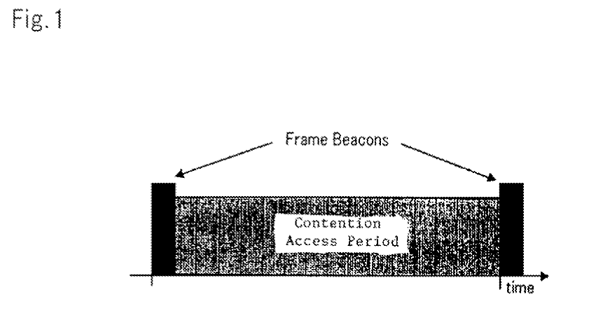

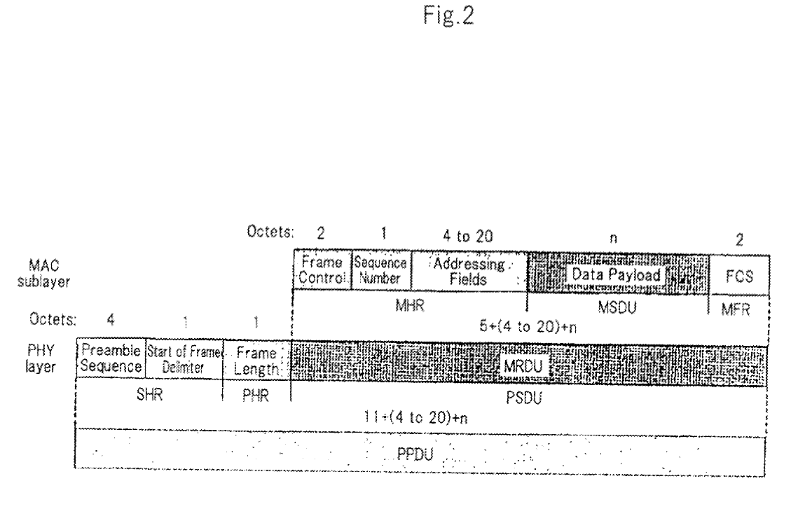

### EXEMPLARY EMBODIMENT

Next, the present invention will be described with reference to the drawings.

### First Exemplary Embodiment

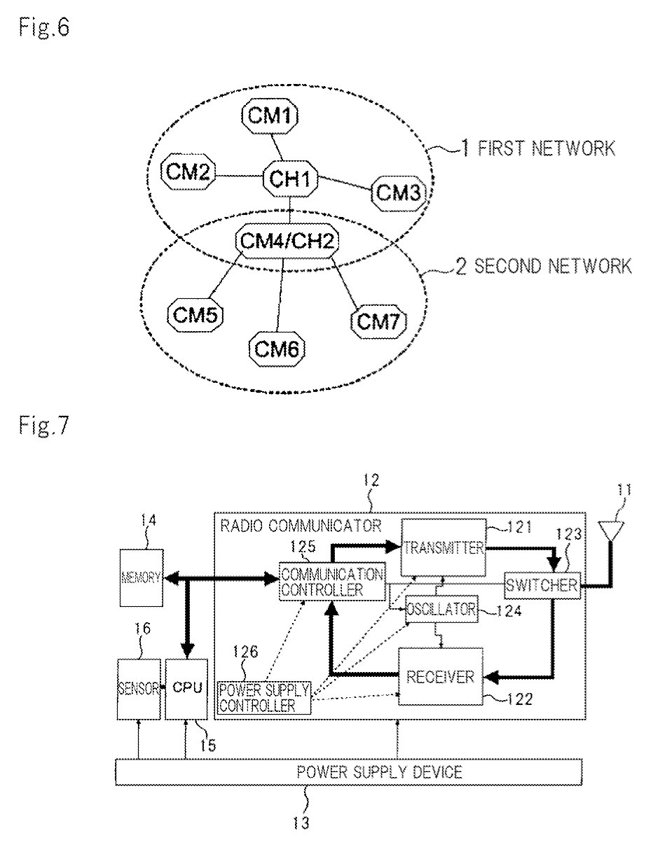

FIG. 6 is a block diagram showing an example of a configuration of a radio communication system.

The radio communication system shown in FIG. 6 comprises first network 1 whose parent node is node CH1, and second network 2 whose parent node is node CH2. First network 1 includes child nodes CM1 to CM4; Second network 2 includes child nodes CM5 to CM7. Child node CM4 of first network 1 also operates as parent node CH2 of second network 2. Although FIG. 6 shows the example where first network 1 includes four child nodes and second network 2 includes three child nodes, the number of child nodes of each network may be arbitrary.

FIG. 7 is a block diagram showing an example of the configuration of the node shown in FIG. 6.

As shown in FIG. 7, the node includes antenna device 11, radio communicator 12, power supply device 13, memory 14, CPU 15 and sensor 16.

CPU 15 controls the overall operation of the node according to, for example, a program stored in memory 14.

Memory 14 is stored with data to be transmitted itself and/or data received from another node.

When, for example, the radio communication system according to the present invention is used for environmental research, sensor 16 is used for measuring surrounding environment (temperature, humidity, atmospheric pressure, position, etc.) of each node. Since sensor 16 is provided according to environment for usage of the radio communication system as necessary, it is not always required.

Power supply device 13 supplies required power supply voltage to each device (radio communicator 12, memory 14, CPU 15, sensor 16, etc.) included in the node.

Radio communicator 12 comprises: transmitter 121 that frequency-converts data to be transmitted into an RF (radio frequency) signal by modulation and amplifies the signal to a power required for transmission and transmits the signal; receiver 122 that amplifies the received RF signal, and frequency-converts and demodulates the signal into a baseband signal; switcher 123 that outputs the RF signal from transmitter 121 to antenna device 11 when transmitting data, and outputs the RF signal received by antenna device 11 to receiver 122 when receiving data; oscillator 124 that generates a local signal required for frequency conversion performed in transmitter 121 and receiver 122; communication controller 125 that performs a required process (encoding, decoding, error correction process and the like) on data to be transmitted/received, and controls communication operation of radio communicator 12 according to the aforementioned slotted CSMA-CA mechanism; and power supply controller 126 that controls power supply to transmitter 121, receiver 122, oscillator 124 and communication controller 125.

Transmitter 121 includes a mixer used for a well-known modulation circuit and frequency conversion, and a power amplifier amplifying the RF signal. Receiver 122 includes a mixer used for a well-known demodulation circuit and frequency conversion, and a low-noise amplifier amplifying the received RF signal. Communication controller 125 includes an A/D (Analog to Digital) converter, a D/A (Digital to Analog) converter, a memory, and an LSI and/or a DSP comprising various logic circuits. Power supply controller 126 is realized by combining various logic circuits. Note that the function of communication controller 125 and the function of power supply controller 126 excluding the A/D conversion and D/A conversion can be realized by a process performed by CPU 14 according to a program.

Typically, each node included in the radio communication system consumes power not only in a data transmission/reception time period but also in a time period of waiting for data reception, because the aforementioned receiver 122, oscillator 124 and communication controller 125 are supplied with power supply voltage. Accordingly, the aforementioned IEEE802.15.4 reduces power consumption of the child node by prescribing a sleep state time period in the child node.

In this exemplary embodiment, a schedule notification signal for providing notification about presence/absence of a schedule of data transmission is transmitted from the child node to the parent node in a predetermined time period between beacon signals. The schedule notification signal may be transmitted from the child node to the parent node only in a case where the schedule of data transmission is present. Instead, the schedule notification signal may be transmitted from the child node to the parent node both in cases when schedule of data transmission is present and when it is absent. The schedule notification signal in the case when the transmission schedule is present and the schedule notification signal in the case when the transmission schedule is absent are transmitted in different slots of the CAP in synchronization therewith.

The parent node waits for the schedule notification signal to be transmitted from the child node for a predetermined time period after transmission of the beacon signal. On reception of the schedule notification signal, the parent node determines presence/absence of the schedule of data transmission from each child node on the basis of the schedule notification signal. The parent node transitions into the sleep state when there is no schedule of data transmission from any child node in the network that the parent node manages and there is no schedule of data transmission from itself to any child node.

The node operates both as the parent node and as the child node, like node CH2 shown in FIG. 6, and may transition into the sleep state, when there is no schedule of data transmission from each of child nodes CM5 to CM7 in second network 2 where it operates as the parent node, and when there is no schedule of data transmission to itself and no schedule of data transmission from parent node CH1 in first network 1 where it operates as the child node.

Here, the sleep state of the node (the parent node and the child node) indicates a state where power supply to transmitter 121, receiver 122, oscillator 124 and communication controller 125 included in radio communicator 12 is wholly cut off under control of power supply controller 126 according to direction by CPU 15 as shown in FIG. 7 for example. In the sleep state, power supply can be cut off not only to transmitter 121, receiver 122, oscillator 124 and communication controller 125, but also to sensor 16. If an individual timer or the like is provided, power supply to CPU 15 may also be cut off. Elements to which power supply is cut off in the sleep state may arbitrarily be determined according to the environment for usage and a device configuration of the radio communication system of this exemplary embodiment.

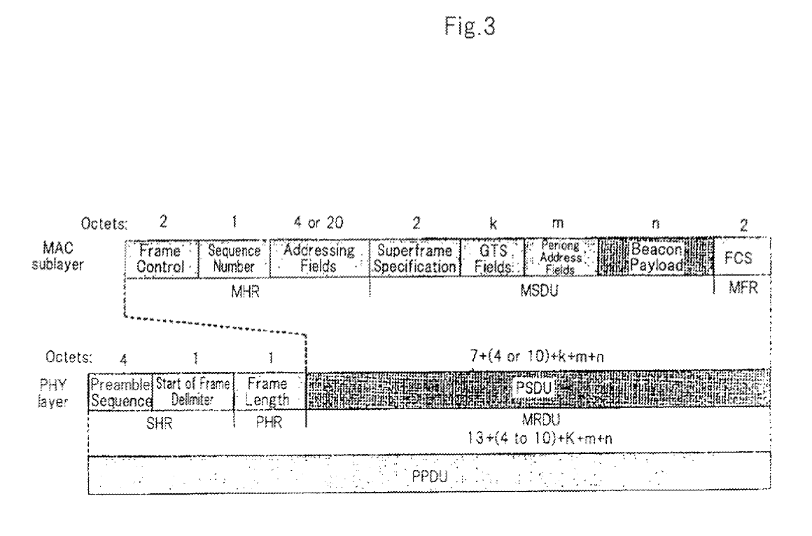

For example, a frame configuration similar to the data frame shown in FIG. 3 is used for the schedule notification signal to be transmitted from the child node. Since the schedule notification signal is in no need of the data payload (Data Payload) shown in FIG. 3, an identification code for identifying the child node transmitting the schedule notification signal may be contained in the data payload area. In this case, the parent node can identify the child node that transmitted the schedule notification signal. Accordingly, the parent node can transition into the sleep state when communication with the child node is finished. If the network includes only one child node, there is no need to include the identification code for identifying the child node in the schedule notification signal. As will be described later, if the parent node only determines the presence/absence of the schedule notification signal, there is also no need to include the identification code for identifying the child node in the schedule notification signal.

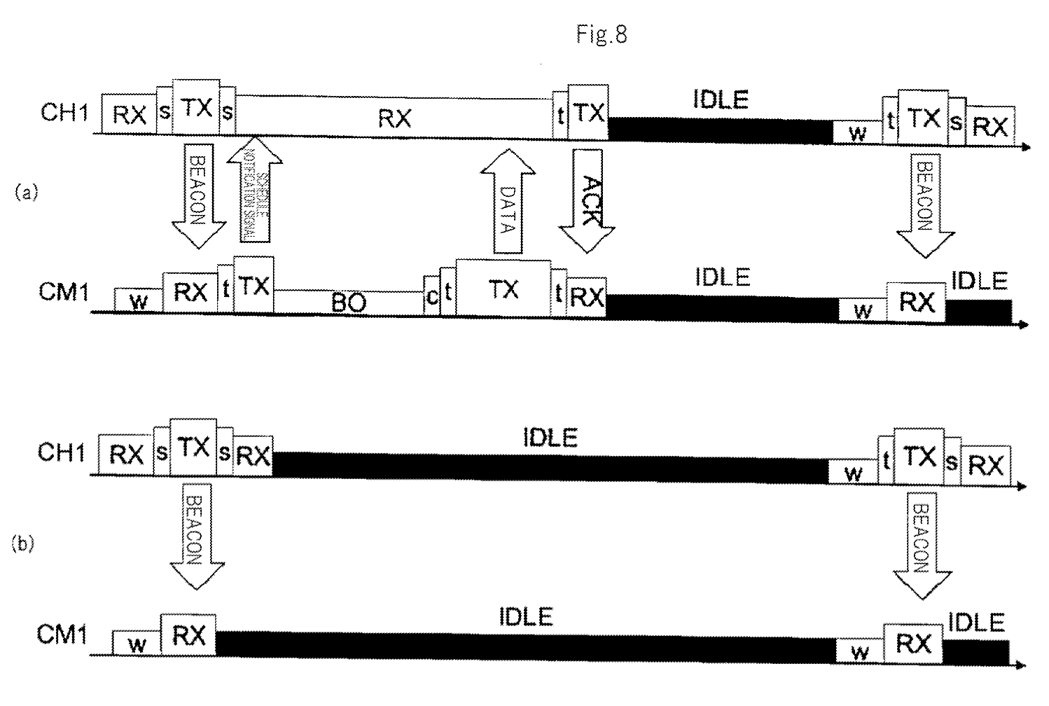

Next, communication operation of the radio communication system according to the first exemplary embodiment will be described with reference to FIG. 8. The communication operation of the node, which will be described below, is performed by communication controller 125 and power supply controller 126 included in radio communicator 12. Likewise, in a second exemplary embodiment and a third exemplary embodiment, which will be described later, communication operation of the node is performed by communication controller 125 and power supply controller 126 included in radio communicator 12.

FIG. 8 is an example where only one child node among child nodes transmits data in the CAP. FIG. 8 shows the communication operation of the radio communication system according to this exemplary embodiment, exemplifying parent node CH1 and child node CM1 included in first network 1 shown in FIG. 6. However, if the number of child nodes that transmit data in each CAP is only one, it can be applied to another parent node and its subordinate child nodes.

“RX” shown in FIG. 8 represents that the node is in a reception state; “TX” represents that the node is in a transmission state; and “IDLE” represents that the node is in a sleep state. “c” shown in FIG. 8 represents a state where the node performs CCA; and “BO” represents that the node is in a backoff state. “s” shown in FIG. 8 denotes a time period of SIFS; “t” denotes a time period (turnaround time period) required to switch between the transmission state and the reception state; and “w” denotes an activation time period required for the node to transition from the sleep state to the transmission/reception state.

Communication operation when there is the schedule of data transmission from child node CM1 to parent node CH1 will be described with reference to FIG. 8 (a).

As shown in FIG. 8 (a), when child node CM1 in the reception state receives the beacon signal from parent node CH1, the child node transitions into the transmission state and transmits the schedule notification signal for providing the schedule of data transmission.

When the beacon signal transmission is finished, parent node CH1 transitions into the reception state and waits for the schedule notification signal to be transmitted from the child node for a predetermined time period. Here, the reception state is maintained and parent node CH1 waits for data to be subsequently transmitted from child node CM1 in order to receive the schedule notification signal from child node CM1.

Child node CM1 transitions into the backoff state after transmitting the schedule notification signal, performs the CCA after the backoff time period elapses, and transitions into the transmission state and transmits data when an available channel exists.

Parent node CH1 detects whether or not the request for return of the ACK is included in the received data frame. When the request for return of the ACK is included, parent node CH1 transitions into transmission state, and returns the ACK to child node CM1 that transmitted the data frame.

Child node CM1 transitions into the reception state after data to be transmitted runs out, and transitions into the sleep state after confirming successful reception of the data frame by parent node CH1 by receiving the ACK. Here, child node CM1 maintains the sleep state until the time of receiving the next beacon signal.

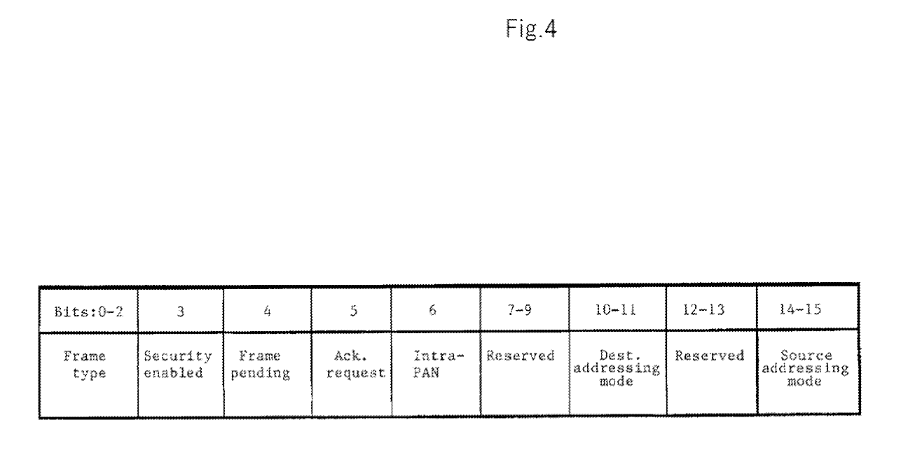

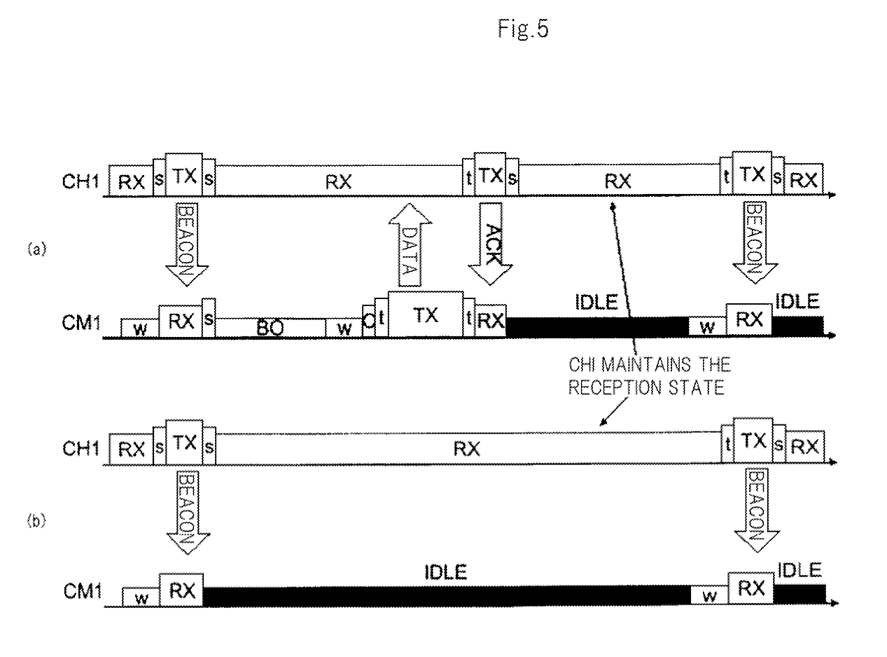

Parent node CH1 determines the originating node (child node CM1) on the basis of the identification code included in the schedule notification signal, and transitions into the sleep state after determining that there is no further data transmission from child node CM1. Here, parent node CH1 maintains the sleep state until the time of transmitting the next beacon signal. As described above, the presence/absence of data transmission from child node CM1 can be determined on the basis of the value of the frame pending of the frame control field in the data frame received from child node CM1 (see FIG. 4).

Next, communication operation without a schedule of data transmission both in child node CM1 and parent node CH1 will be described using FIG. 8 (b).

As shown in FIG. 8 (b), child node CM1 detects whether or not the pending address field in the beacon signal received from parent node CH1 contains the identification code for identifying itself. Child node CM1 transitions into the sleep state when determining that the pending address field does not contain the identification code for identifying itself when there is no schedule of transmission to child node CM1. Child node CM1 maintains the sleep state until the time of receiving the next beacon signal.

When the transmission of the beacon signal is finished, parent node CH1 transitions into the reception state and waits for the schedule notification signal to be transmitted from the child node for the predetermined time period. Since parent node CM1 cannot detect the schedule notification signal from child node CM1 here, the parent node transitions into the sleep state when the predetermined time period elapses. Parent node CH1 maintains the sleep state until the time of transmitting the next beacon signal.

The radio communication system according to this exemplary embodiment can provide a time period of the sleep state in the parent node, thereby allowing power consumption of the parent node to be reduced.

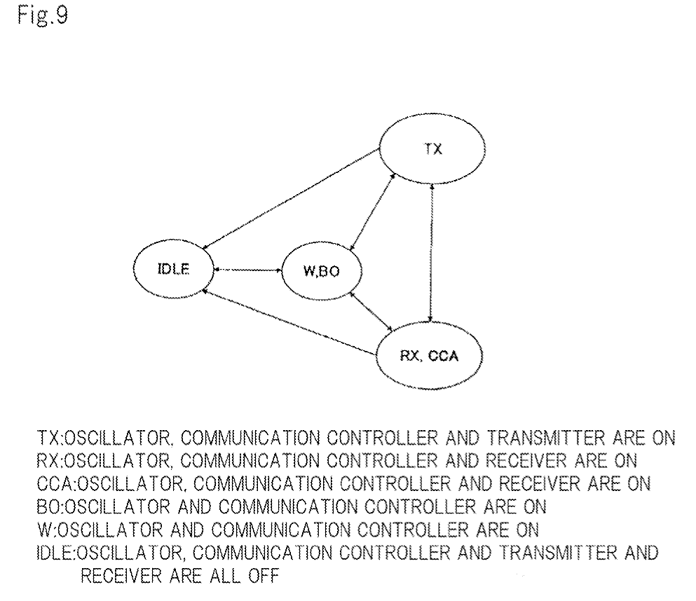

The state transition in communication of the parent node and child node CM1 described above can be shown as in FIG. 9.

As shown in FIG. 9, when the node is in the transmission state (TX), oscillator 124, communication controller 125 and transmitter 121 are turned on (supplied with power supply voltage) in radio communicator 12. When the node is in the reception state (RX) or executing the CCA, oscillator 124, communication controller 125 and receiver 122 are turned on in radio communicator 12. When the node is in the backoff state (BO) or in the activation state from the sleep state (w), oscillator 124 and communication controller 125 are turned on in radio communicator 12. When the node is in the sleep state (IDLE), oscillator 124, communication controller 125, transmitter 121 and receiver 122 are all turned off.

The aforementioned description has shown the example where child node CM1 transmits the schedule notification signal to parent node CH1 only when there is a schedule of data transmission. However, analogous advantageous effects are exerted also when child node CM1 transmits the schedule notification signal to parent node CH1 both in cases where a schedule of transmission is present and where there is no schedule of transmission.

### Second Exemplary Embodiment

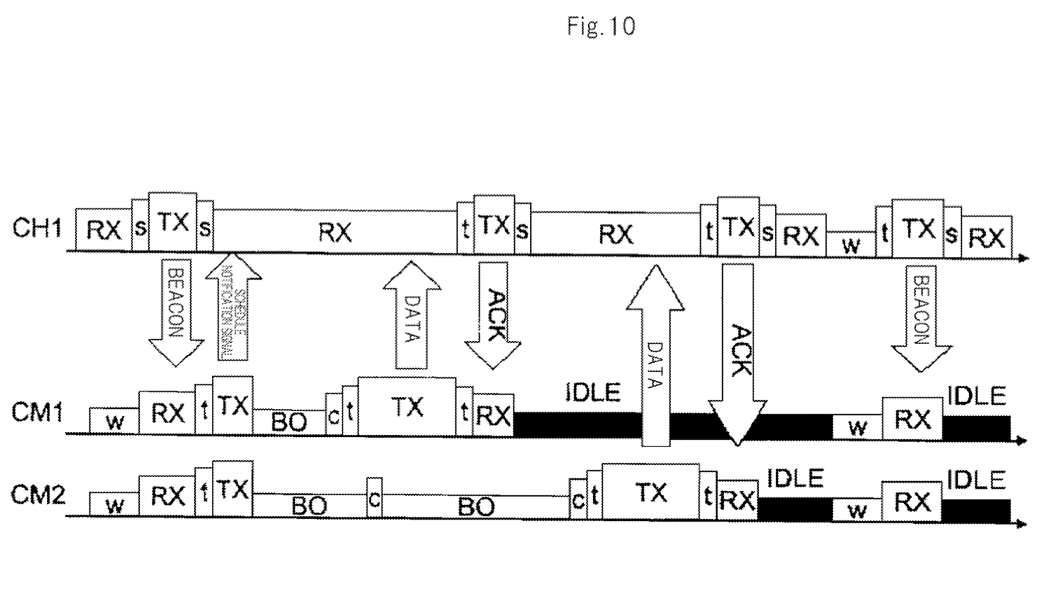

FIG. 10 is a schematic diagram showing an example of communication operation of a radio communication system according to a second exemplary embodiment.

The radio communication system according to the second exemplary embodiment is an example where a plural number of child nodes having a schedule of data transmission exist and the child nodes transmit the schedule notification signals to the parent node at the same time. FIG. 10 shows an example where two child nodes CM1 and CM2 have a schedule of data transmission and the schedule notification signals are transmitted from child nodes CM1 and CM2 to parent node CH1 at the same time for the sake of simplifying the description.

As with the first exemplary embodiment, “RX” shown in FIG. 10 represents that the node is in the reception state; “TX” represents that the node is in transmission state; and “IDLE” represents that the node is in the sleep state. “c” shown in FIG. 10 represents a state where the node performs the CCA; and “BO” represents that the node is in backoff state. “s” shown in FIG. 10 denotes a time period of SIFS; “t” denotes a time period (turnaround time period) required to switch between the transmission state and the reception state; and “w” denotes an activation time period required for the node to transition from the sleep state to the transmission/reception state.

Provided that a plural number of child nodes having a schedule of data transmission exist, transmission of the schedule notification signal from each child node triggered by reception of the beacon signal, which is one-to-many communication, causes the schedule notification signals to collide with each other and the parent node cannot distinguish the content of the schedule notification signal. Thus, in the second exemplary embodiment, the parent node determines only the presence/absence of the schedule notification signal from the child node by measuring reception power intensity. When the parent node determines that the schedule notification signal exists, the parent node does not transition into the sleep state, but maintains the reception state until the time of transmitting the next beacon signal, even if the parent node detects that data to be transmitted runs out in the child node on the basis of the value of the frame pending of the received data frame. On the other hand, in a case where the parent node cannot detect the schedule notification signal, the parent node transitions into the sleep state after a prescribed time period within which the schedule notification signal that should be transmitted elapses. This exemplary embodiment can be applied to a case where the child node transmits the schedule notification signal to the parent node only if the schedule of data transmission exists.

Since the configuration of the node and the state transition of the node are analogous to those of the first exemplary embodiment, the description thereof is omitted.

As shown in FIG. 10, regarding the schedules of data transmission from child nodes CM1 and CM2 to parent node CH1, when the child nodes CM1 and CM2 receive the beacon signal from the parent node CH1 in the reception state, child nodes CM1 and CM2 transition into the transmission state and transmit the schedule notification signal for providing the schedule of data transmission.

When parent node CH1 finishes the transmission of the beacon signal, parent node CH1 transitions into the reception state and waits for the schedule notification signal to be transmitted from the child node for the predetermined time period. Here, parent node CH1 cannot distinguish the content of the schedule notification signal because the schedule notification signals from child nodes CM1 and CM2 collide with each other.

When parent node CH1 finishes the transmission of the beacon signal, parent node CH1 measures the intensity of the reception radio wave over a predetermined time period and determines the presence/absence of the schedule notification signal from the child node on the basis of the intensity value of the reception radio wave.

After parent node CH1 detects the presence of the schedule notification signal on the basis of the intensity value of the reception radio wave, parent node CH1 maintains the reception state and waits for data to be transmitted from child nodes CM1 and CM2.

After transmitting the schedule notification signal, child node CM1 transitions into the backoff state. After the backoff time period elapses, child node CM1 performs the CCA. When there is an available channel, child node CM1 transitions into the transmission state and transmits data.

Parent node CH1 determines whether the received data frame contains a request for return of the ACK or not. When the request for return of the ACK is contained in the received data frame, parent node CH1 transitions into the transmission state and returns the ACK to child node CM1 that transmitted the data frame.

When data to be transmitted runs out, child node CM1 transitions into the reception state. After confirming successful reception of the data frame at parent node CH1 by reception of the ACK, child node CM1 transitions into the sleep state. Here, child node CM1 maintains the sleep state until the time of receiving the next beacon signal.

After transmitting the schedule notification signal, child node CM2 transitions into the backoff state. When the backoff time period elapses, child node CM2 performs the CCA. When there is an available channel, child node CM2 transitions into the transmission state and transmits data.

Parent node CH1 determines whether the received data frame contains the request for return of the ACK or not. When the request for return of the ACK is contained in the received data frame, parent node CH1 transitions into the transmission state and returns the ACK to the child node CM2 that transmitted the data frame.

When data to be transmitted runs out, child node CM2 transitions into the reception state. After confirming successful reception of the data frame at parent node CH1 by reception of the ACK, child node CM2 transitions into the sleep state. Here, child node CM2 maintains the sleep state until the time of receiving the next beacon signal.

Parent node CH1 can detect that data to be transmitted runs out in child nodes CM1 and CM2 on the basis of the values of the frame pending of the data frames transmitted from child nodes CM1 and CM2. However, parent node CH1 here cannot determine the content of the schedule notification signal transmitted from child nodes CM1 and CM2. Accordingly, parent node CH1 does not transition into the sleep state, but maintains the reception state until the time of transmitting the next beacon signal.

In the absence of any schedule of data transmission both in child nodes CM1 and CM2 and parent node CH1, child nodes CM1 and CM2 detect whether or not the pending address field in the beacon signal received from parent node CH1 contains the identification code for identifying itself. Child nodes CM1 and CM2 transition into the sleep state when determining that the pending address field does not contain the identification code for identifying itself and there is no schedule of data transmission to itself. Here, child nodes CM1 and CM2 maintain the sleep state until the time of receiving the next beacon signal.

After transmitting the beacon signal, parent node CH1 transitions into the reception state and waits for the schedule notification signal to be transmitted from the child node for the predetermined time period. There is no schedule notification signal from child nodes CM1 and CM2. Accordingly, when the predetermined time period elapses, the parent node transitions into the sleep state. Parent node CH1 maintains the sleep state until the time of transmitting the next beacon signal.

Even if a collision occurs by transmitting the schedule notification signals from child nodes at the same time, the parent node may sometimes detect the schedule notification signal of any one of the child nodes because of the difference between intensities of the radio waves of the child nodes. In this case, if the parent node transitions into the sleep state when communication with the child node whose schedule notification signal is detected is finished as in the first exemplary embodiment, delay in communication occurs during which another child node having the schedule of data transmission cannot communicate with the parent node until receiving the next beacon signal.

In this exemplary embodiment, the parent node determines only the presence/absence of the schedule notification signal on the basis of the value of the intensity of the reception radio wave. When there is a schedule notification signal, the parent node does not transition into the sleep state even if communication with the child node, whose schedule notification signal is detected, is finished. Accordingly, delay in communication does not occur even in the child node that has the schedule of data transmission, and its schedule notification signal is not detected by the parent node.

According to the radio communication system of this exemplary embodiment, even if a plural number of child nodes having the schedules of data transmission exist and even if the child nodes transmit the schedule notification signals to the parent node at the same time, the parent node can be provided with the time period in the sleep state as in the first exemplary embodiment, thereby allowing the power consumption of the parent node to be reduced.

### Third Exemplary Embodiment

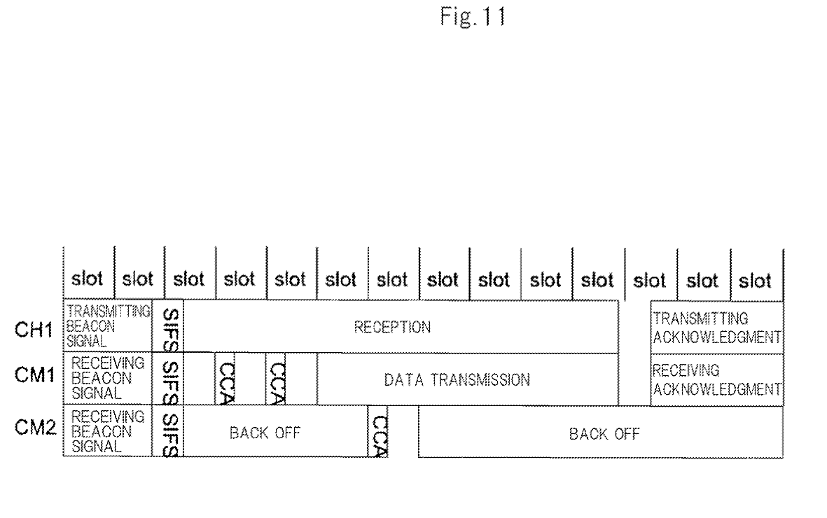

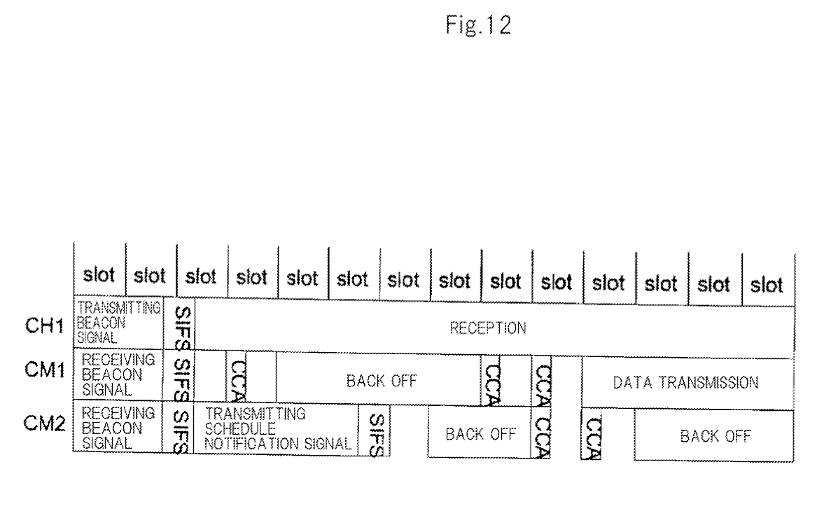

FIGS. 11 and 12 are schematic diagrams showing an example of the communication operation of a radio communication system according to a third exemplary embodiment.

The radio communication system according to the third exemplary embodiment is an example where the nodes shown in the first and second exemplary embodiments and the node shown in the background art coexist with each other.

Since the configuration of the node and the state transition of the node are analogous to those of the first and second exemplary embodiments, the description thereof is omitted.

FIG. 11 shows an example of a communication operation of each node in a case where only parent node CH1 is the node shown in the first and second exemplary embodiments and child nodes CM1 and CM2 are the nodes shown in the background art.

FIG. 12 shows an example of a communication operation of each node in a case where parent node CH1 and child node CM2 are the nodes shown in the first and second exemplary embodiments and child node CM1 is the node shown in the background art. In the example shown in FIG. 12, the backoff state that occurs in child node CM1 first after reception of the beacon signal is a time period corresponding to 0 slot.

According to a system configuration operating as shown in FIG. 11, the schedule notification signals are not transmitted from child nodes CM1 and CM2, and parent node CH1 cannot detect the schedule notification signals.

According to a system configuration operating as shown in FIG. 12, in a case where child node CM1 has the schedule of data transmission and child node CM2 does not have the schedule of data transmission, child node CM1 cannot transmit data to the parent node if the parent node transitions into the sleep state immediately after transmitting the beacon signal because of the absence of the schedule notification signal from child node CM2.

Thus, the radio communication system according to this exemplary embodiment adopts any one of the following three measures.

(1) The parent node does not transition into the sleep state irrespective of the presence/absence of the schedule notification signal from the child node. In this case, the system operates in a fashion analogous to the radio communication system shown in the background art.

(2) A dedicated slot is provided for communication with the child node shown in the background art. The communication with this child node is performed using the dedicated slot. The parent node does not transition into the sleep state for the time period for the dedicated slot even when the schedule notification signal from the child node does not exist. The parent node transitions into the sleep state in time periods of other slots when there is no schedule of data transmission from the child node.

(3) Parent node CH1 transitions into the sleep state when the predetermined constant time period elapses after transmitting the beacon signal, in a case where the schedule notification signal from the child node does not exist. The child node shown in the background art becomes able to communicate by transmitting data to the parent node within the predetermined constant time period.

According to the system configuration operating as shown in FIG. 12, when child node CM2 transmits the schedule notification signal immediately after reception of the beacon signal, child node CM1 detects that the channel is in use by the CCA and transitions into the backoff state again.

Thus, if transmission of the schedule notification signal starts within two slots after transmission/reception of the beacon signal, coexistence of the nodes shown in the first and second exemplary embodiments and the node shown in the background art does not cause inconvenience. From a standpoint of reduction in power consumption of the parent node, if there is no schedule of data transmission from the child node, it is preferable that parent node CH1 transition into the sleep state as soon as possible after transmission of the beacon signal is finished. Also in this respect, the schedule notification signal is preferably transmitted within two slots after transmission/reception of the beacon signal is finished.

According to the radio communication system of this exemplary embodiment, if the node of the present invention and the node shown in the background art coexist, adoption of the aforementioned method (2) or (3) enables the parent node to be provided with the time period in the sleep state as in the first exemplary embodiment, thereby allowing power consumption of the parent node to be reduced.

With respect to the first to third exemplary embodiments, operation of the radio communication system according to the present invention has been described, exemplifying the radio communication system employing IEEE802.15.4. However, application of the present invention to a radio communication system employing another communication protocol, such as IEEE802.11, other than IEEE802.15.4 also exerts analogous advantageous effects.

The present application claims priority based on Japanese Patent Application No. 2007-192020 filed on Jul. 24, 2007, which is herein incorporated by reference in its entirety.

1-11. (canceled)

12. A radio communication system comprising a parent node transmitting a beacon signal as one-to-many communication at every constant period, and a child node receiving the beacon signal, said parent node and said child node operating in synchronization with each other by using said beacon signal,
wherein said child node
transmits a schedule notification signal for providing notification of presence/absence of a schedule of data transmission to said parent node, within a predetermined time period between said beacon signals, and
said parent node
determines presence/absence of said schedule notification signal by measuring reception power intensity over said predetermined time period.

13. The radio communication system according to claim 12,
wherein an interval between said beacon signals comprises slots that comprise a fixed period and are for operating said parent node and said child node in synchronization with each other, and
said predetermined time period
is a time period corresponding to an interval within two slots after reception of said beacon signal.

14. The radio communication system according to claim 12,
wherein said parent node
transitions into a sleep state until a time of transmitting the next beacon signal, when said parent node cannot detect said schedule notification signal in said predetermined time period.

15. The radio communication system according to claim 12,
wherein said schedule notification signal
includes an identification code for identifying said child node.

16. The radio communication system according to claim 15,
wherein said parent node
transitions into the sleep state until the time of transmitting the next beacon signal after transmission of data including the identification code from said child node, in a case where the identification code for identifying said child node included in said schedule notification signal is detected.

17. A power-saving method of a radio communication system comprising a parent node transmitting a beacon signal as one-to-many communication at every constant period, and a child node receiving the beacon signal, the parent node and the child node operating in synchronization with each other by using said beacon signal, including:
transmitting a schedule notification signal, for providing notification of presence/absence of a schedule of data transmission, from said child node to said parent node, within a predetermined time period between said beacon signals; and
causing said parent node to transition into a sleep state until a time of transmitting the next beacon signal, when said parent node cannot detect said schedule notification signal within the predetermined time period,
wherein said parent node determines presence/absence of said schedule notification signal by measuring reception power intensity over said predetermined time period.

18. The power-saving method of the radio communication system according to claim 17,
wherein an interval between said beacon signals comprises slots that comprise a fixed period and are for operating said parent node and said child node in synchronization with each other, and
said predetermined time period is a time period corresponding to an interval within two slots after reception of said beacon signal.

19. The power-saving method of the radio communication system according to claim 17, wherein said schedule notification signal includes an identification code for identifying said child node.

20. The power-saving method of the radio communication system according to claim 19, wherein the parent node transitions into the sleep state until the time of transmitting the next beacon signal after transmission of data including the identification code from said child node, in a case where the identification code for identifying said child node included in said schedule notification signal is detected.
